(19) United States
(12) Patent Application Publication
(10) Pub. No.: US 2020/0073347 A1
(43) Pub. Date: Mar. 5, 2020

(54) MULTI-MODE AND LOW-ENERGY INDOOR THERMAL CONDITIONING METHOD

(71) Applicant: Guangdong University of Technology, Guangzhou (CN)

(72) Inventors: Jianguo MA, Guangzhou (CN); Shaohua ZHOU, Guangzhou (CN); Chujie LU, Guangzhou (CN)

(21) Appl. No.: 16/266,063

(22) Filed: Feb. 3, 2019

(30) Foreign Application Priority Data
Sep. 5, 2018 (CN) 201811033805.0

(51) Int. Cl. G05B 19/042; F24F 11/63

(52) U.S. Cl. CPC G05B 19/042; F24F 2110/10; F24F 11/63

(57) ABSTRACT

The present disclosure discloses a multi-mode and low-energy indoor thermal conditioning method, which utilizes various indoor thermal conditioning means to form a plurality of thermal conditioning schemes, and then performs offline prediction on indoor thermal environment parameters in each mode, establishes an input/output database according to a human comfort model, optimizes a current optimal adjustment mode in real time through system identification, and can update the input/output database according to user feedback. The method of the present disclosure solves the problem of the user's arbitrariness and blindness in the settings of an air conditioner, and other low-energy thermal conditioning means can compensate the somatosensory temperature by using the air flow, thereby increasing the set temperature value of the air conditioner or reducing the opening time of the air conditioner, and further realizing the energy saving of construction equipment while creating a comfortable and healthy indoor thermal environment.

### CROSS-REFERENCE TO RELATED APPLICATION

This application claims the priority to Chinese Patent Application No. 201811033805.0 filed on Sep. 5, 2018. The content of the aforementioned application, including any intervening amendments thereto, are incorporated herein by reference.

### TECHNICAL FIELD

The present disclosure relates to the field of intelligent building, in particular to a multi-mode and low-energy indoor thermal conditioning method.

### TECHNICAL BACKGROUND

With the rapid economic development, air-conditioning equipment has rapidly spread in people's daily lives and has become the most important means of indoor thermal conditioning. At the same time, people's requirements for the construction environment continue to increase, and existing air conditioning technology has the following drawbacks:

The air conditioning operation parameter setting relies on the user's “trial adjustment”, the setting process has blindness and randomness, and it takes a long time to reach a satisfactory indoor thermal environment.

An air conditioning control method widely used is to simply perform feedback control based on a set value (temperature), that is, the sensors are only set at a return air inlet of an air conditioner or at indoor limited positions; but the sensing parameter is single, the distribution of thermal environment parameters in the human activity areas cannot be accurately reflected, and the indoor environment is often too hot or too cold.

The air supply of a single air conditioner is difficult to meet the thermal comfort of the human in a large space, and the air supply dead angle is easy to exist. The existing intelligent research and patents neglect other indoor thermal conditioning methods (such as natural ventilation, mechanical ventilation, fans, etc.), and such equipment have the characteristics of low energy consumption and flexible setting, which can simultaneously create a comfortable thermal environment of the human and realize building energy saving.

Also, the long-term use of air conditioners (separate type, etc.) is easy to lead to a lack of fresh air indoors, resulting in high indoor carbon dioxide concentration, which is easy to cause a systemic human health problem such as “sick building syndrome”.

In summary, the existing air-conditioning technology has a low level of intelligence, cannot predict and determine the human's thermal sensation, and cannot perform linkage control in combination with multiple thermal conditioning equipment, so that it is difficult to create a personalized, comfortable, safe and healthy indoor thermal environment and the equipment consume more energy.

### SUMMARY

In view of the deficiencies in the prior art, an object of the present disclosure is to provide a multi-mode and low-energy indoor thermal conditioning method, which performs linkage control on indoor thermal conditioning means (such as fans and air conditioners, air conditioning units and the like), and uses a Computational Fluid Dynamics (CFD) method to offline predict the indoor thermal environment under each environmental parameter and each thermal conditioning mode, so as to determine the current optimal thermal conditioning mode in real time, thereby creating a healthy and comfortable indoor environment.

In order to achieve the above tasks, the present disclosure adopts the following technical solutions:

A multi-mode and low-energy indoor thermal conditioning method, comprising steps of:

Step 1 (S101), developing a thermal regulation scheme according to the type and quantity of indoor thermal conditioning equipment;

Step 2 (S102), determining a range of changes of environment parameters inside and outside a room according to the area and season of the room;

Step 3 (S103), establishing a Computational Fluid Dynamics (CFD) model of the indoor environment;

Step 4 (S104), performing CFD numerical simulation on the CFD model;

Step 5 (S105), using a suitable human thermal comfort evaluation model as an evaluation index to determine a preferred algorithm;

Step 6 (S106), first establishing an input database, inputting each set of parameters in the database as different combination of the environmental parameters, and then determining each set of parameters in the input database as a corresponding thermal regulation scheme in the thermal boundary condition, and finally establishing input/output database;

Step 7 (S107), identifying indoor environmental parameters and comparing them with the input/output database;

Step 8 (S108), determining current optimal thermal regulation mode to implement a control action so as to adjust each indoor thermal conditioning equipment so that a comfortable indoor thermal environment suitable for the human body is obtained;

Step 9 (S109), re-identifying the indoor environmental parameters by sensing the indoor thermal environment using a sensing module, and re-comparing them with the input/output database, and then re-determining the current optimal thermal regulation mode to implement the control action so as to adjust each indoor thermal conditioning equipment so that a comfortable indoor thermal environment suitable for the human body is obtained.

Further, the multi-mode and low-energy indoor thermal conditioning method further comprises:

obtaining thermal sensory feedback of an indoor user to the current thermal conditioning scheme, and optimizing said input/output database by the thermal sensory feedback.

Further, the indoor thermal conditioning equipment described in step 1 comprises a floor-standing fan and a cabinet-type air conditioner, and thermal conditioning means of the respective devices include: the outlet wind speed U_{F} of the floor-standing fan, the position X_{F} of the floor-standing fan, the supply air temperature T_{A} of the air conditioner, the air supply wind speed U_{A} of the air conditioner; and the thermal conditioning means are combined differently to obtain different thermal conditioning schemes.

Further, each set of parameters in the input database described in step 6 is a different combination of environmental parameters, wherein the environmental parameters include: indoor temperature, outdoor temperature, indoor humidity, outdoor humidity, and wall temperature.

Further, the human thermal comfort evaluation model described in step 5 is:

Predicted Mean Vote (PMV)=

(0.303e^{-0.036M}+0.028){M−W−3.05×10⁻³×[5733−6.99(M−W)−p_{w}] i.

−0.42×[(M−W)−58.15]−1.7×10⁻⁵M(5867−p_{w})−0.0014M(34−T) ii.

−3.96×10⁻⁸f×[(t+273)⁴−(Tr+273)⁴]−f·h(t−T)} iii.

in the above formula:

$$t = 35.7 - 0.028 ( M - W ) - I [ 3.96 \times {10}^{- 8} f \times [ {( t + 273 )}^{4} - {( Tr + 273 )}^{4} ] + fh ( t - T ) ]$$

$$h = \{ \begin{matrix}2.38 {( t - T )}^{0.25} & if 2.38 {( t - T )}^{0.25} > 12.1 \sqrt{\vert U \vert} \\ 12.1 \sqrt{\vert U \vert} , & if 2.38 {( t - T )}^{0.25} < 12.1 \sqrt{\vert U \vert}\end{matrix} \\ f = \{ \begin{matrix}1.00 + 1.290 I , & if I \leq 0.078 {m}^{2} ° C . / W \\ 1.05 + 0.6445 I , & if I > 0.078 {m}^{2} ° C . / W\end{matrix}$$

in the above formulas, W is the work done by a human, M is the metabolic activity, I is the thermal resistance of garment, T is the air temperature, Tr is the average radiant temperature, U is the air flow rate, and p_{w} is the relative humidity or water vapor pressure.

Further, adopting the way of performing the numerical simulation method on said CFD model to determine the thermal conditioning scheme corresponding to each set of parameters in the input database as the thermal boundary condition comprises: creating an objective function O(ξ):

$$O ( ξ ) = \frac{{\int }_{Ω} {( PMV )}^{2} d Ω }{{\int }_{Ω} d Ω}$$

in the above formula, Ω is a design area, ξ is a design variable corresponding to the thermal conditioning scheme established in step 1;

initializing said design variable, taking each set of parameters in the input database as the thermal boundary condition, adopting the Renormalization Group (RNG) k-smodel as a turbulence model, adopting the SIMPLE algorithm to couple speed/accompanying speed and pressure/accompanying pressure to establish the Navier-Stokes equation, applying CFD software OpenFOAM to solve the Navier-Stokes equation, and using the solution results to calculate an objective function value; when solving, iteratively establishing a loop and calculating a corresponding objective function value, and when the objective function converges, outputting the corresponding ξ.

Further, said Navier-Stokes equation is:

N=(N₁,N₂,N₃,N₄,N₅):

N₁=−∇·U=0

(N₂,N₃,N₄)^{T}=(U·∇)U+∇·(2νD(U))−γg(T−Tₒₚ)=0

N₅=∇·(UT)−∇·(κ∇T)=0

in the above equations, N₁ is a continuity equation, N₂, N₃, and N₄ are momentum equations, N₅ is an energy equation, U is the air flow rate, ν is the effective viscosity, D is the strain rate tensor, T is the air temperature, Tₒₚ is the operating temperature, γ is the thermal diffusivity, g is the acceleration of gravity, and κ is the thermal conductivity.

Further, the criteria for convergence of the objective function are:

criterion 1: in the first iteration, if O(ξ)<Ψ, then determining O(ξ) converges; Ψ>0;

criterion 2: in the i^{th} iteration, if ∥Oᵢ(ξ)−Oᵢ₋₁(ξ)∥<Φ, then determining that Oᵢ(ξ) converges; where, Φ>0, Oᵢ(ξ) is the objective function value calculated at the i^{th} iteration, and Oᵢ₋₁(ξ) is the objective function value calculated at the i−1^{th} iteration.

Further, in the iterative process, the design variable ξ is updated in the following manner:

calculating (pₐ,Uₐ,Tₐ) by an adjoint equation, where the adjoint equation is as follows:

$$- ∇ {U}_{a} = 0 \\ - ∇ {U}_{a} \cdot U - ( U \cdot ∇ ) {U}_{a} - ∇ \cdot ( 2 vD ( {U}_{a} ) ) + ∇ {p}_{a} + {T}_{a} ∇ T + A = 0 \\ - U \cdot ∇ {T}_{a} - ∇ \cdot ( κ ∇ {T}_{a} ) + B = 0$$

$$A = \{ \begin{matrix}2 \times PMV \times \frac{\partial PMV}{\partial U} , & area Ω \\ 0 , & area Θ \backslash Ω\end{matrix} \\ B = \{ \begin{matrix}2 \times PMV \times \frac{\partial PMV}{\partial T} , & area Ω \\ 0 , & area Θ \backslash Ω\end{matrix}$$

by applying the steepest descent algorithm, the change in the design variable ξ can be written as:

$$δ ξ = - {λ [ \frac{\partial O}{\partial ξ} + {\int }_{Ω} ( {p}_{a} , {U}_{a} , {T}_{a} ) \frac{\partial N}{\partial ξ} d Θ ]}^{T}$$

in the above formula, λ is a constant greater than 0, O is the objective function O(ξ), and the calculated (pₐ, Uₐ, Tₐ) is substituted into the above formula to obtain δξ, and then the design variable ξ is updated by:

ξ_{new}=ξ_{old}+δξ

in the above formula, ξ_{new} is the design variable after updating and ξ_{old} is the design variable before updating.

Compared with the prior art, the present disclosure has the following technical features.

The present disclosure fully mobilizes various thermal conditioning means indoors, utilizes the air flow to compensate the temperature by a low energy consumption means such as a fan, can improve the air conditioning temperature setting value, reduce the energy consumption of the building equipment; offline predict the indoor thermal environment, and optimize the adjusting mode in real time. It solves the problem of blindness and randomness of the indoor thermal conditioning scheme, and effectively creates an indoor thermal environment such as comfort and health.

### BRIEF DESCRIPTION OF THE DRAWINGS

FIG. 1 is a schematic flowchart of a method of the present disclosure;

FIG. 2 is a schematic diagram of an indoor environment in an embodiment.

### DETAILED DESCRIPTION

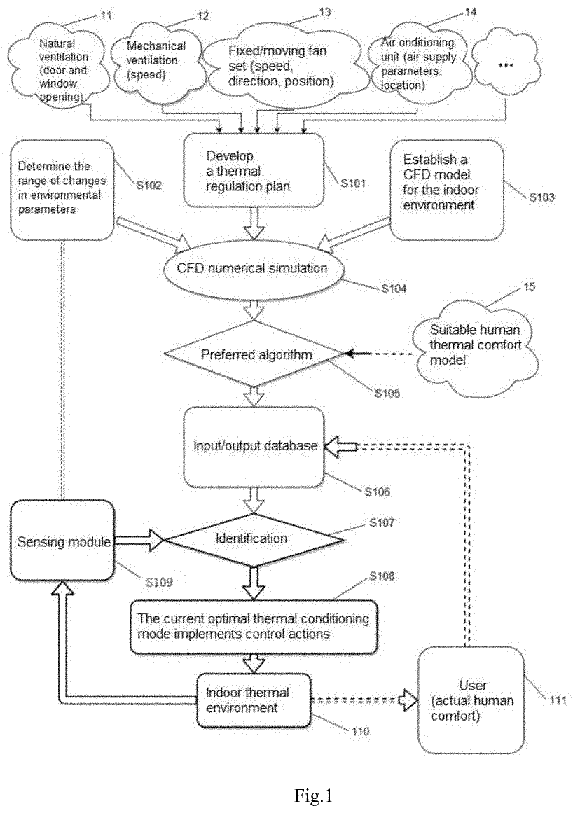

As shown in FIG. 1, the present disclosure discloses a multi-mode and low-energy indoor thermal conditioning method, comprising the following steps.

Step 1, determining a thermal conditioning scheme according to the type and number of indoor thermal conditioning equipment

The indoor thermal conditioning equipment refers to, for example, a fan, an air conditioner, an air heater, etc., and the thermal conditioning schemes are different schemes for differently combining adjustment means of the indoor thermal conditioning equipment to adjust the indoor temperature.

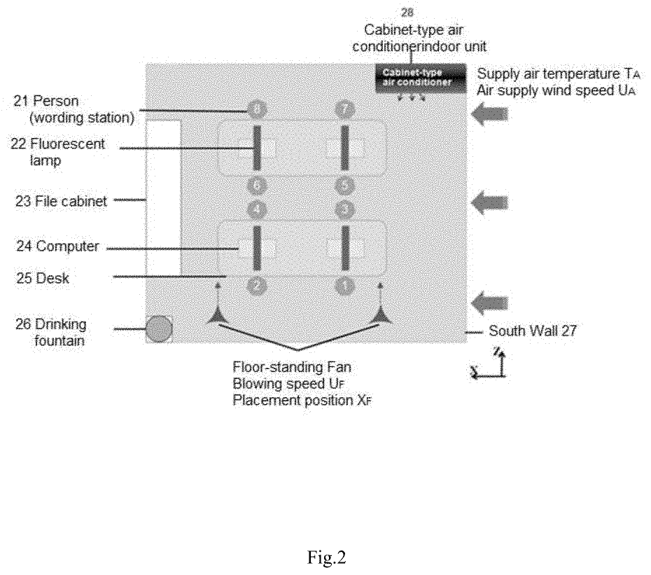

For example, in an example given in FIG. 2, the indoor thermal conditioning equipment 28 includes a floor-standing fan and a cabinet-type air conditioner, which are located at positions close to a rear wall and a front wall in the room, respectively. The adjustment parameters are indoor temperature and air flow rate, and the adjustment means of each device include: the outlet wind speed U_{F} (0-2.5 m/s) of the floor-standing fan, the position X_{F} (2 m-8 m) of the floor-standing fan, the supply air temperature T_{A} (22° C.−26° C.) of the air conditioner 28, the air supply wind speed U_{A} (0-2.5 m/s) of the air conditioner. The position of the floor-standing fan refers to the distance between the floor-standing fan and a side wall in the room.

The thermal conditioning scheme is to combine the adjustment means described. For example, a set of thermal conditioning schemes [U_{F},X_{F},T_{A},U_{A}] may be: the outlet wind speed of the floor-standing fan being 2 m/s, the position of the floor-standing fan being 5 m; the air supply wind speed of the air conditioner being 2 m/s, and the supply air temperature of the air conditioner 28 being 23° C. When the value of each adjustment means is different, the combinations of respective adjustment means can thus form a large number of thermal conditioning schemes, and the combined thermal conditioning schemes are saved. Among others, the combined change interval of the outlet wind speed of the floor-standing fan and the air supply wind speed of the air conditioner can be 0.5 m/s, and there can be five values, respectively; the combined change interval of the fan position is 0.5 m, and there can be twelve values; the combined change interval of the supply air temperature of the air conditioner is 0.5° C., and there can be eight values. According to such intervals, in this embodiment, a total of 5×5×12×8=2400 thermal conditioning schemes can be generated.

When there is a plurality of thermal conditioning equipment, the adjustment means of each thermal conditioning equipment are separately combined to form a thermal conditioning scheme.

Step 2, according to the area and season of a room, determining the range of changes of the environment parameters inside and outside the room, and establishing an input database, where each set of parameters are different combinations of said environmental parameters

In this step, by a sensing module, for example, a temperature and humidity sensor or a temperature and humidity meter installed indoors or outdoors, a range of changes of environmental parameters inside and outside the room is determined, and the environmental parameters include: indoor temperature, outdoor temperature, indoor humidity, outdoor humidity, and (indoor) wall temperature. By querying the records of a previous year, an average value of the change range of each environmental parameter in one day can be obtained, and then each environmental parameter is cross-combined into different parameter groups according to a fixed interval and an input database is established and saved, as shown in the following example:

TABLE 1
Example of Input Database

| | Parameter | | | | |
|---|---|---|---|---|---|
| | Outdoor | Outdoor | Indoor | Indoor | Wall |
| | Temperature | Humidity | Temperature | Humidity | Temperature |
| No | 30~35° C. | 50%~75% | 28~35° C. | 65%~75% | 23~25° C. |
| 1 | 30 | 50 | 23 | 65 | 23 |
| 2 | 31 | 50 | 23 | 65 | 23 |
| . . . | . . . | . . . | . . . | . . . | . . . |

In this example, the temperature interval is 1° C., and the humidity interval is 2%. First, the values of outdoor temperature, indoor temperature, indoor humidity, and wall temperature are fixed, and the outdoor temperature is changed at the interval of 1° C. to form multiple groups of parameter sets; then the outdoor humidity is changed at the interval of 2%, and other parameters are fixed to form multiple groups of parameter sets; by analogy, an input database formed by different combinations of environmental parameters can be obtained.

Step 3, establishing a CFD (Computational Fluid Dynamics) model of the room

Obtain the structures and parameters of the indoor environment in the room, including the size, orientation and internal main structure. CFD modeling is performed by using computational fluid dynamics numerical simulation software, such as COMSOL Multiphysics® simulation platform, and meshing is performed after modeling. As shown in FIG. 2, in this embodiment, the room is an office, and the environment structure in the room is: the size of 10 m×3 m×10 m; the thermal conditioning equipment: 1 cabinet-type air conditioner 28, 1 floor-standing fan; others: 8 persons (working station) 21, 8 computers 24, 4 fluorescent lamps 22, 1 water dispenser (drinking fountain) 26, and 1 file cabinet 23.

8 persons (working station) 21, 8 computers 24, 4 fluorescent lamps 22 and 1 water dispenser 26 are set at a fixed heat flow rate, respectively; the wall, floor and ceiling are set as a temperature boundary; the air supply outlet of the air conditioner is set as a speed inlet boundary, the return air inlet of the air conditioner 28 is a natural outflow boundary, and the floor-standing fan is set to an internal fan type.

The relevant model definition and solution strategy are: indoor gaseous atmosphere is assumed to be incompressible viscous Newtonian fluid of low velocity flow, the RNG k-ε model is used for a turbulence model, the standard wall function is used for wall treatment, Boussinesq approximation is used for buoyancy effect, viscous heating is not considered, the SIMPLE algorithm can be adopted for pressure and velocity coupling calculation; the second-order difference method is selected for all the temperature, pressure and momentum equations, and the first-order difference method is selected for component equations; default values are selected for respective relaxation factors, and the number of iterations is set to 500 times.

Step 4, using a human thermal comfort evaluation model as an evaluation index, adopting a way of performing a numerical simulation method on said CFD model to determine a thermal conditioning scheme corresponding to each set of parameters in the input database as a thermal boundary condition, and establishing an input/output database

Step 4.1, establishing a human thermal comfort evaluation model

In this embodiment, the human comfort is evaluated by comprehensively considering environmental factors such as temperature, humidity, air flow rate, and average radiation temperature in the indoor human activity area, and a human thermal comfort evaluation model PMV at the person (working station) is established as follows:

PMV=(0.303e^{-0.036M}+0.028){M−W−3.05×10⁻³×[5733−6.99(M−W)−p_{w}]−0.42×[(M−W)−58.15]−1.7×10⁻⁵M(5867−p_{w})−0.0014M(34−T)−3.96×10⁻⁸f×[(t+273)⁴−(Tr+273)⁴]−f·h(t−T)}

in the above formula:

$$t = 35.7 - 0.028 ( M - W ) - I [ 3.96 \times {10}^{- 8} f \times [ {( t + 273 )}^{4} - {( Tr + 273 )}^{4} ] + fh ( t - T ) ]$$

$$h = \{ \begin{matrix}2.38 {( t - T )}^{0.25} & if 2.38 {( t - T )}^{0.25} > 12.1 \sqrt{\vert U \vert} \\ 12.1 \sqrt{\vert U \vert} , & if 2.38 {( t - T )}^{0.25} < 12.1 \sqrt{\vert U \vert}\end{matrix} \\ f = \{ \begin{matrix}1.00 + 1.290 I , & if I \leq 0.078 {m}^{2} ° C . / W \\ 1.05 + 0.6445 I , & if I > 0.078 {m}^{2} ° C . / W\end{matrix}$$

in the above formulas, W is the work done by the human, M is the metabolic activity, I is the thermal resistance of the garment, T is the air temperature, Tr is the average radiant temperature, U is the air flow rate, p_{w} is the relative humidity or water vapour pressure. For the simplified calculation, assuming that the average radiant temperature Tr is the same as the air temperature T, and the state variables of the indoor thermal environment in this embodiment are: air temperature T, air flow rate U, and pressure p.

Step 4.2, adopting a way of performing a numerical simulation method on said CFD model to determine a thermal conditioning scheme corresponding to each set of parameters in the input database as a thermal boundary condition

The numerical simulation method used in the present scheme may be a genetic algorithm or an accompanying method, or an artificial neural network may be used to establish a training sample; in this embodiment, a method combining computational fluid dynamics (CFD) and an accompanying method is selected.

The design goal of this scheme is to achieve indoor thermal comfort. For the indoor thermal comfort, the value of the thermal comfort evaluation model PMV should be close to zero, and an objective function is established accordingly:

$$O ( ξ ) = \frac{{\int }_{Ω} {( PMV )}^{2} d Ω }{{\int }_{Ω} d Ω}$$

In the above formula, the PMV is the human thermal comfort evaluation model established in Step 4.1, Ω is a design area, i.e. at the person (working station), and ξ is a design variable, wherein the design variable corresponds to the thermal conditioning scheme established in Step 1, i.e., the value of the design variable is [U_{F},X_{F},T_{A},U_{A}]. The numerical simulation process is namely to seek the minimum value of the objective function O(ξ). The steps of the numerical simulation process are as follows.

\textcircled{1} Initializing the design variable ξ

In this embodiment, the design variable ξ is initialized with the intermediate values in the adjustment parameter range of each thermal conditioning equipment. For example, the fan blowing air speed U_{F}(0-2.5 m/s) is 1.25 m/s, the fan position X_{F}(2 m-8 m) is 5 m, the supply air temperature T_{A}(22° C.−26° C.) of the air conditioner is 24° C., and the air supply wind speed U_{A}(0-2.5 m/s) of the air conditioner is 1.25 m/s; that is, the initial value of ξ is [1.25 m/s,5 m,24° C.,1.25 m/s].

\textcircled{2} The state variables of the indoor thermal environment are controlled by the state equations of air flow, and thus the Navier-Stokes (N-S) equation is established and expressed as:

N=(N₁,N₂,N₃,N₄,N₅):

N₁=−∇·U=0

(N₂,N₃,N₄)^{T}=(U·∇)U+∇·(2νD(U))−γg(T−Tₒₚ)=0

N₅=∇·(UT)−∇·(κ∇T)=0

in the above equations, N₁ is a continuity equation, N₂, N₃, and N₄ are momentum equations, N₅ is an energy equation, U is the air flow rate, ν is the effective viscosity, D is the strain rate tensor, T is the air temperature, Tₒₚ is the operating temperature, γ is the thermal diffusivity, g is the acceleration of gravity, and κ is the thermal conductivity.

Combine the design variable ξ, use each set of parameters in the input database described in Step 2 as the thermal boundary condition, adopt the RNG k-ε model as the turbulence model, adopt the SIMPLE algorithm to couple speed/accompanying speed and pressure/accompanying pressure to establish the Navier-Stokes equation, apply CFD software OpenFOAM to solve the Navier-Stokes equation, and use the solution results to calculate an objective function value; when solving, iteratively establish a loop and calculate a corresponding objective function value, and when the objective function converges, output the corresponding ξ, i.e. obtain a corresponding thermal regulation scheme for each set of parameters as the thermal boundary condition.

\textcircled{3} Determining Convergence

criterion 1: in the first iteration, if O(ξ)<Ψ, then determining that O(ξ) converges; Ψ>0;

criterion 2: in the i^{th} iteration, if ∥Oᵢ(ξ)−Oᵢ₋₁(ξ)∥<Φ, then determining that Oᵢ(ξ) converges; where, Φ>0, Oᵢ(ξ) is the objective function value calculated at the i^{th} iteration, and Oᵢ₋₁(ξ) is the objective function value calculated at the i−1^{th} iteration.

In this embodiment, the values of Ψ and Φ are all 0.01.

After each iteration, it is determined whether the objective function converges by the above criteria. If it converges, the iteration ends. At this time, the corresponding thermal conditioning scheme corresponding to the design variable ξ is a preferred implementation scheme; if it does not converge, \textcircled{4} is executed;

\textcircled{4} Solving the Adjoint Equation

Search for a new design variable ξ by determining the derivative dO(ξ)/dξ of the objective function on the design variable, and use the new design variable ξ for the next iteration to make the value of the objective function O(ξ) smaller.

In order to facilitate calculating dO(ξ)/dξ, a Lagrangian operator (pₐ,Uₐ,Tₐ) is introduced, in which pₐ,Uₐ,Tₐ are the accompanying velocity, the accompanying pressure and the accompanying temperature, respectively, and the augmented objective function L is established by the Lagrangian multiplier method:

L=O+∫_{Ω}(pₐ,Uₐ,Tₐ)·NdΘ

In the above formula, O is the objective function O(ξ), Ω is the design area, N is the Navier-Stokes equation, and Θ represents the calculation domain; since N=0, the objective function can be expressed as:

$$dO \approx d L = \frac{\partial L}{\partial ξ} \cdot d ξ + \frac{\partial L}{\partial {U}_{a}} \cdot d {U}_{a} + \frac{\partial L}{\partial {p}_{a}} \cdot {dp}_{a} + \frac{\partial L}{\partial {T}_{a}} \cdot d {T}_{a}$$

Let the last three items on the right side of the above formula be 0, and obtain:

$$\frac{d O}{d ξ} = \frac{\partial L}{\partial ξ} = \frac{\partial O}{\partial ξ} + {\int }_{Ω} ( {p}_{a} , {U}_{a} , {T}_{a} ) \frac{\partial N}{\partial ξ} d Θ$$

The adjoint equation in this embodiment is obtained by derivation and integral transformation:

$$- ∇ {U}_{a} = 0 \\ - ∇ {U}_{a} \cdot U - ( U \cdot ∇ ) {U}_{a} - ∇ \cdot ( 2 vD ( {U}_{a} ) ) + ∇ {p}_{a} + {T}_{a} ∇ T + A = 0 \\ - U \cdot ∇ {T}_{a} - ∇ \cdot ( κ ∇ {T}_{a} ) + B = 0$$

$$A = \{ \begin{matrix}2 \times PMV \times \frac{\partial PMV}{\partial U} , & area Ω \\ 0 , & area Θ \backslash Ω\end{matrix} \\ B = \{ \begin{matrix}2 \times PMV \times \frac{\partial PMV}{\partial T} , & area Ω \\ 0 , & area Θ \backslash Ω\end{matrix}$$

Solve the above adjoint equation to obtain the solution (pₐ,Uₐ,Tₐ)

\textcircled{5} Updating the Design Variable ξ

By applying the steepest descent algorithm, the change in the design variable ξ can be written as:

$$δ ξ = - {λ [ \frac{\partial O}{\partial ξ} + {\int }_{Ω} ( {p}_{a} , {U}_{a} , {T}_{a} ) \frac{\partial N}{\partial ξ} d Θ ]}^{T}$$

in the above formula, λ is a constant greater than 0, O is the objective function O(ξ), and (pₐ,Uₐ,Tₐ) calculated in Step \textcircled{4} is substituted into the above formula to obtain δξ, and then the design variable ξ is updated by:

ξ_{new}=ξ_{old}+δξ

in the above formula, ξ_{new} is the design variable after updating and ξ_{old} is the design variable before updating.

Substitute the updated design variable ξ_{new} as parameter ξ into Step \textcircled{2} and continue the iteration until the objective function converges. When the changes in the thermal conditioning scheme (such as fan position) in the loop require re-meshing, the Gambit file is used to automatically generate a corresponding grid.

Step 4.3, establishing an input/output database

After Step 4.2, the corresponding design variable ξ is obtained when each set of parameters in the input database is used as a thermal boundary condition. A design variable is a thermal conditioning scheme established in Step 1, namely a preferred implementation scheme under the thermal boundary conditions.

Take each set of parameters in the input database as input, the thermal conditioning scheme corresponding to the design variable ξ is taken as an output, and the mapping relationship is saved, thereby establishing an input/output database, that is, the mapping correspondence between thermal conditioning schemes in Table 1 and Step 1 are saved in the input/output database.

Step 5, according to the current indoor and outdoor environmental parameters, obtaining a thermal conditioning scheme through the input/output database, and then adjusting the indoor thermal conditioning equipment according to the thermal conditioning scheme

The indoor and outdoor environmental parameters of the room are consistent with those in Step 2, including indoor temperature, outdoor temperature, indoor humidity, outdoor humidity, and (indoor) wall temperature. These parameters can be obtained in real time by the temperature and humidity sensor, and these parameters are taken as one group and matched with the input database of Table 1. With adopting the method of fuzzy comparison or similarity comparison, for example, find the closest set of parameters S in the input database, and then through the input/output database, find a thermal conditioning scheme corresponding to the set of parameters S as the current thermal conditioning scheme, and output it through a display device.

For the adjustment process, automatic or manual adjustment is possible. For the manual adjustment, a user manually adjusts the thermal conditioning equipment according to the thermal conditioning scheme output on the display device.

For the automatic adjustment, it is necessary to use a controller and connect the controller to the air conditioner and the fan, respectively. For example, for the air conditioner, the supply air temperature of the air conditioner and the air supply wind speed of the air conditioner in the thermal conditioning scheme can be taken as target values, and the automatic adjustment is performed by the controller. However, for the position adjustment of the fan, a linear drive mechanism can be installed to the bottom of the fan and the controller is used to adjust the position of the linear drive mechanism.

This step can be performed once at an interval, for example at the interval of 20 minutes.

Step 6, obtaining thermal sensory feedback of an indoor user to the current thermal conditioning scheme, and optimizing said input/output database by the thermal sensory feedback

In this embodiment, the thermal sensation feedback includes cold, heat, blowing, and stuffy:

when the thermal sensation feedback is cold, the supply air temperature of the air conditioner can be turned up/the outlet wind speed of the fan can be reduced, and the adjusted values are recorded in the input/output database;

when the thermal sensation feedback is hot, the supply air temperature of the air conditioner can be turned down/the outlet wind speed of the fan can be increased, and the adjusted values are recorded in the input/output database;

when the thermal sensation feedback is blowing, the fan speed can be reduced and the supply air temperature of the air conditioner can be turned down, and the adjusted values are recorded in the input/output database;

when the thermal sensation feedback is stuffy, the outlet wind speed of the fan can be increased and the set temperature of the air conditioner can be turned up, and the adjusted values are recorded in the input/output database.

Step 6 is implemented by a user interaction module, which can use a touch display screen together with the display device described in step 5; for the current thermal conditioning scheme [U_{F},X_{F},T_{A},U_{A}], the corresponding input to the input/output database is R1, which combines the user-adjusted parameters with the unadjusted parameters to form a new current thermal conditioning scheme, and uses this thermal conditioning scheme to update the current thermal conditioning scheme in the input/output database.

For example, after obtaining the current indoor and outdoor environment parameters of the room, the input matched in the input database is R1, and the thermal conditioning scheme corresponding to R1 in the input/output database is [U_{F},X_{F},T_{A},U_{A}]. The thermal conditioning scheme [U_{F},X_{F},T_{A},U_{A}] is utilized to adjust the indoor thermal conditioning equipment. When the user's thermal sensory feedback is cold, the user turns up the set temperature T_{A} of the air conditioner to T_{A1} through the user interaction module, and then the updated new current thermal conditioning scheme is [U_{F},X_{F},T_{A1},U_{A}]. This set of parameters is used to update the thermal conditioning scheme corresponding to the input/output database R1 and is saved.

1. A multi-mode and low-energy indoor thermal conditioning method, comprising:
Step 1 (S101), developing a thermal regulation scheme according to the type and quantity of indoor thermal conditioning equipment;
Step 2 (S102), determining a range of changes of environment parameters inside and outside a room according to the area and season of the room;
Step 3 (S103), establishing a Computational Fluid Dynamics (CFD) model of the indoor environment;
Step 4 (S104), performing CFD numerical simulation on the CFD model;
Step 5 (S105), using a suitable human thermal comfort evaluation model as an evaluation index to determine a preferred algorithm;
Step 6 (S106), first establishing an input database, inputting each set of parameters in the database as different combination of the environmental parameters, and then determining each set of parameters in the input database as a corresponding thermal regulation scheme in the thermal boundary condition, and finally establishing input/output database;
Step 7 (S107), identifying indoor environmental parameters and comparing them with the input/output database;
Step 8 (S108), determining current optimal thermal regulation mode to implement a control action so as to adjust each indoor thermal conditioning equipment so that a comfortable indoor thermal environment suitable for the human body is obtained;
Step 9 (S109), re-identifying the indoor environmental parameters by sensing the indoor thermal environment using a sensing module, and re-comparing them with the input/output database, and then re-determining the current optimal thermal regulation mode to implement the control action so as to adjust each indoor thermal conditioning equipment so that a comfortable indoor thermal environment suitable for the human body is obtained.

2. The multi-mode and low-energy indoor thermal conditioning method according to claim 1, further comprises:
obtaining thermal sensory feedback of an indoor user to the current thermal conditioning scheme, and optimizing said input/output database by the thermal sensory feedback.

3. The multi-mode and low-energy indoor thermal conditioning method according to claim 1, wherein the indoor thermal conditioning equipment described in step 1 comprises a floor-standing fan and a cabinet-type air conditioner, and thermal conditioning means of the respective devices include: an outlet wind speed U_{F} of the floor-standing fan, a position X_{F} of the floor-standing fan, a supply air temperature T_{A} of the air conditioner, an air supply wind speed U_{A} of the air conditioner; and the thermal conditioning means are combined in different ways to obtain different thermal conditioning schemes.

4. The multi-mode and low-energy indoor thermal conditioning method according to claim 1, wherein each set of parameters in the input database described in step 6 is a different combination of environmental parameters, wherein the environmental parameters include: indoor temperature, outdoor temperature, indoor humidity, outdoor humidity, and wall temperature.

5. The multi-mode and low-energy indoor thermal conditioning method according to claim 1, wherein the human thermal comfort evaluation model described in step 5 is:
PMV=(0.303e^{-0.036M}+0.028){M−W−3.05×10⁻³×[5733−6.99(M−W)−p_{w}]−0.42×[(M−W)−58.15]−1.7×10⁵M(5867−p_{w})−0.0014M(34−T)−3.96×10⁻⁸f×[(t+273)⁴−(Tr+273)⁴]−f·h(t−T)}
wherein:
$$t = 35.7 - 0.028 ( M - W ) - I [ 3.96 \times {10}^{- 8} f \times [ {( t + 273 )}^{4} - {( Tr + 273 )}^{4} ] + fh ( t - T ) ]$$
$$h = \{ \begin{matrix}2.38 {( t - T )}^{0.25} & if 2.38 {( t - T )}^{0.25} > 12.1 \sqrt{\vert U \vert} \\ 12.1 \sqrt{\vert U \vert} , & if 2.38 {( t - T )}^{0.25} < 12.1 \sqrt{\vert U \vert}\end{matrix} \\ f = \{ \begin{matrix}1.00 + 1.290 I , & if I \leq 0.078 {m}^{2} ° C . / W \\ 1.05 + 0.6445 I , & if I > 0.078 {m}^{2} ° C . / W\end{matrix}$$
wherein, W is a work done by a human, M is a metabolic activity, I is a thermal resistance of garment, T is an air temperature, Tr is an average radiant temperature, U is an air flow rate, and p_{w} is a relative humidity or water vapor pressure.

6. The multi-mode and low-energy indoor thermal conditioning method according to claim 1, wherein adopting the way of performing the numerical simulation method on said CFD model to determine the thermal conditioning scheme corresponding to each set of parameters in the input database as the thermal boundary condition comprises:
creating an objective function O(ξ):
$$O ( ξ ) = \frac{{\int }_{Ω} {( PMV )}^{2} d Ω }{{\int }_{Ω} d Ω}$$
wherein, Ω is a design area, ξ is a design variable corresponding to the thermal conditioning scheme established in step 1; and
initializing said design variable, taking each set of parameters in the input database as the thermal boundary condition, adopting an RNG k-ε model as a turbulence model, adopting a SIMPLE algorithm to couple speed/accompanying speed and pressure/accompanying pressure to establish a Navier-Stokes equation, applying CFD software OpenFOAM to solve the Navier-Stokes equation, and using solution results to calculate an objective function value; when solving, iteratively establishing a loop and calculating a corresponding objective function value, and when the objective function converges, outputting the corresponding ξ.

7. The multi-mode and low-energy indoor thermal conditioning method according to claim 6, wherein said Navier-Stokes equation is:
N=(N₁,N₂,N₃,N₄,N₅):
N=−∇·U=0
(N₂,N₃,N₄)^{T}=(U·∇)U+∇·(2νD(U))−γg(T−Tₒₚ)=0
N₅=∇·(UT)−∇·(κ∇T)=0
wherein, N₁ is a continuity equation, N₂,N₃ and N₄ are momentum equations, N₅ is an energy equation, U is an air flow rate, ν is an effective viscosity, D is a strain rate tensor, T is an air temperature, Tₒₚ is an operating temperature, γ is a thermal diffusivity, g is an acceleration of gravity, and κ is a thermal conductivity.

8. The multi-mode and low-energy indoor thermal conditioning method according to claim 6, wherein criteria for convergence of the objective function are:
criterion 1: in a first iteration, if O(ξ)<Ψ, then determining that O(ξ) converges; Ψ>0;
criterion 2: in an i^{th} iteration, if ∥Oᵢ(ξ)−Oᵢ₋₁(ξ)∥<Φ, then determining that Oᵢ(ξ) converges; where, Φ>0, Oᵢ(ξ) is the objective function value calculated at the i^{th} iteration, and Oᵢ₋₁(ξ) is the objective function value calculated at the i−1^{th} iteration.

9. The multi-mode and low-energy indoor thermal conditioning method according to claim 6, wherein in the iterative process, the design variable ξ is updated in the following manner:
calculating (pₐ,Uₐ,Tₐ) by an adjoint equation, where the adjoint equation is as follows:
$$- ∇ {U}_{a} = 0 \\ - ∇ {U}_{a} \cdot U - ( U \cdot ∇ ) {U}_{a} - ∇ \cdot ( 2 vD ( {U}_{a} ) ) + ∇ {p}_{a} + {T}_{a} ∇ T + A = 0 \\ - U \cdot ∇ {T}_{a} - ∇ \cdot ( κ ∇ {T}_{a} ) + B = 0$$
$$A = \{ \begin{matrix}2 \times PMV \times \frac{\partial PMV}{\partial U} , & area Ω \\ 0 , & area Θ \backslash Ω\end{matrix} \\ B = \{ \begin{matrix}2 \times PMV \times \frac{\partial PMV}{\partial T} , & area Ω \\ 0 , & area Θ \backslash Ω\end{matrix}$$
by applying the steepest descent algorithm, the change in the design variable ξ can be written as:
$$δ ξ = - {λ [ \frac{\partial O}{\partial ξ} + {\int }_{Ω} ( {p}_{a} , {U}_{a} , {T}_{a} ) \frac{\partial N}{\partial ξ} d Θ ]}^{T}$$
wherein, λ is a constant greater than 0, O is an objective function O(ξ), and the calculated (pₐ,Uₐ,Tₐ) is substituted into the above formula to obtain δξ, and then the design variable ξ is updated by:
ξ_{new}=ξ_{old}+δξ
in the above formula, ξ_{new} is the design variable after updating and ξ_{old} is the design variable before updating.
